(19) United States
(12) Patent Application Publication
(10) Pub. No.: US 2014/0214612 A1
(43) Pub. Date: Jul. 31, 2014

(54) CONSUMER TO CONSUMER SALES ASSISTANCE

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/756,381

(22) Filed: Jan. 31, 2013

(51) Int. Cl. G06Q 30/06

(52) U.S. Cl. CPC G06Q 30/0613
USPC 705/26.41

(57) ABSTRACT

A computer-implemented method is disclosed herein. The method includes the step of receiving, with a processing device of a commerce server, a help request signal from a first augmented reality device worn by a current consumer considering an item for purchase in a retail store. The method also includes the step of searching, with the processing device, a consumer database wherein the consumer database contains purchase histories for a plurality of past consumers. The method also includes the step of identifying, with the processing device, a past consumer in the consumer database who purchased the item. The method also includes the step of transmitting, with the processing device, a communication request signal to a second augmented reality device worn by the past consumer containing data indicative of a request that the past consumer communicate with the current consumer about the item. The past consumer can assist the current consumer in considering the item for purchase.

### BACKGROUND INFORMATION

1. Field of the Disclosure

The present invention relates generally to assisting a consumer in reaching a decision to purchase an item. In particular, a consumer can be linked, in real time, with another consumer who has purchased the item of interest.

2. Background

Some retail stores extend across tens of thousands of square feet and offer thousands of items for sale. Many consumers visit such retail stores when shopping for a diverse set of items such as groceries, office supplies, and household wares. Typically, these stores can have dozens of aisles and/or departments. It can be challenging to find a store employee to assist with a purchasing decision. A consumer can become frustrated when time must be spent looking for help. Further, if a large number of different items are offered for sale at the retail store, it is possible that when an employee is found that employee may not be knowledgeable about the particular item of interest to the consumer. A consumer may become frustrated by this chain of events and might pursue purchasing the item at another retail store.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is an example schematic illustrating a system according to some embodiments of the present disclosure.

FIG. 2 is an example block diagram illustrating an augmented reality device unit that can be applied in some embodiments of the present disclosure.

FIG. 3 is an example block diagram illustration of a commerce server that can be applied in some embodiments of the present disclosure.

FIG. 4A is an exemplary field of view of a current consumer while shopping in some embodiments of the present disclosure.

FIG. 4B is an exemplary field of view of a past consumer while assisting a current consumer in some embodiments of the present disclosure.

FIG. 5 is an example flow chart illustrating a method that can be carried out according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Embodiments of the present disclosure can assist consumers that are shopping in a retail store. An embodiment of the present disclosure can assist a consumer by providing sales assistance promptly so that the consumer can exercise a purchasing decision without the stress that can be associated with finding a knowledgeable sales assistant. An embodiment of the present disclosure can help reduce the time and stress that can arise while shopping and thus make the shopping trip a more enjoyable and satisfying experience.

A consumer assistance system according to some embodiments of the present disclosure can be operable to receive a help request signal from an augmented reality device worn by a current consumer shopping in a retail store. A help request signal can contain data indicative of the current consumer's desire for sales assistance. The current consumer may be deciding between competing brands of a particular item for purchase. Alternatively, the current consumer may be deciding between items that are distinct but share some common functional capability, such as an e-reader and a tablet computer. An augmented reality device worn by the current consumer can be configured to receive and transmit video data, audio data, and other types of data.

A consumer assistance system according to some embodiments of the present disclosure can be operable to link the current consumer with a past consumer in response to receiving the help request signal. For example, the augmented reality device worn by the current consumer can be placed in communication with another augmented reality device worn by a past consumer. The past consumer can share his experience with an item that the current consumer is considering for purchase.

Embodiments of the present disclosure provide numerous benefits to consumers. For example, a consumer is not required to search through the retail store for an employee to assist in a purchasing decision. Assistance can be provided at the location of the consumer within the retail store. Further, the consumer is not at risk of wasting effort, such as when an employee of the retail store, when found, does not possess the knowledge needed to assist the consumer. Embodiments of the present disclosure can allow a current consumer to obtain prompt assistance from another consumer having knowledge that will be useful to the current consumer.

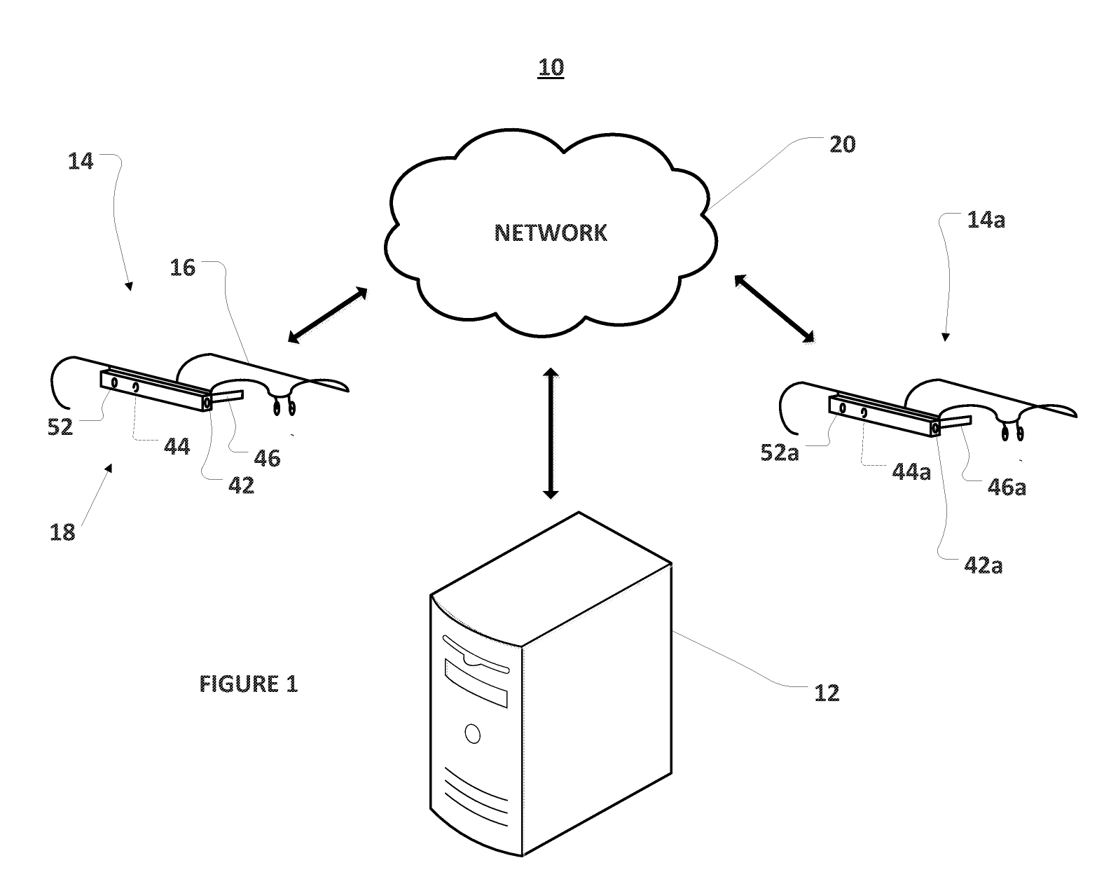

FIG. 1 is a schematic illustrating a consumer assistance system 10 according to some embodiments of the present disclosure. The consumer assistance system 10 can execute a computer-implemented method that includes the step of receiving, with a commerce server 12, a help request signal from an augmented reality device worn by a consumer shopping in a retail store. The help request can be an audio signal, a video signal or can contain both audio and video data.

The help request signal can be communicated to the commerce server 12 with an augmented reality device such as a head mountable unit 14. The head mountable unit 14 can be worn by a consumer while the consumer is shopping within the retail store. In the illustrated embodiment of FIG. 1, the exemplary head mountable unit 14 includes a frame 16 and a communications unit 18 supported on the frame 16. A second consumer, a past consumer, can be wearing a second augmented reality device, such as a head mountable unit 14a. The head mountable units 14, 14a can be substantially similar. The description of the head mountable unit 14 contained herein can therefore also be applicable to the head mountable unit 14a.

Signals transmitted by the head mountable unit 14 and received by the commerce server 12, and vice-versa, can be communicated over a network 20. As used herein, the term “network” can include, but is not limited to, a Local Area Network (LAN), a Metropolitan Area Network (MAN), a Wide Area Network (WAN), the Internet, or combinations thereof. Embodiments of the present disclosure can be practiced with a wireless network, a hard-wired network, or any combination thereof.

The commerce server 12 can determine that the help request signal contains data indicative of a request for sales assistance. For example, the signal can be an audio signal containing the consumer's voice stating a request for help. In response to receiving the help request signal, the commerce server 12 can attempt to link the head mountable unit 14 worn by the current consumer with the head mountable unit 14a worn by a past consumer. The commerce server 12 can transmit an acceptance signal to the head mountable unit 14a worn by the past consumer. In some embodiments of the present disclosure, the past consumer can verbally accept the request for help. The past consumer can verbally communicate acceptance. The microphone 44a of the head mountable unit 14a can capture the past consumer's acceptance in an audio signal and the audio signal can be transmitted to the commerce server 12 over the network 20.

The commerce server 12 can link the head mountable unit 14 and the head mountable unit 14a to permit communication between the current consumer and a past consumer. In some embodiments of the present disclosure, the head mountable unit 14a can be located in the same retail store with the current consumer. In some embodiments of the present disclosure, the head mountable unit 14a can be remote from the retail store occupied by the current consumer.

The operator of the head mountable unit 14a is a past consumer operable to assist the current consumer. For example, the current consumer can verbally state questions about various items that are being considered for purchase. The statements of the current consumer can be captured by a microphone 44 of the head mountable unit 14 and transmitted by the head mountable unit 14 to the commerce server 12. The initial signal can be denoted as a help request signal and subsequent signals originating from the current consumer during the interaction with the past consumer can be denoted as current consumer communication signals.

The commerce server 12 can receive the help request signal and one or more subsequent current consumer communication signals from the current consumer. The commerce server 12 can transmit the help request and consumer communication signals to the past consumer operating the head mountable unit 14a. The verbal statements of the current consumer can be emitted through a speaker 52a of the head mountable unit 14a, allowing the past consumer to hear the current consumer's statements.

The past consumer can verbally respond to the current consumer's statements. The statements of the past consumer can be captured by a microphone 44a of the head mountable unit 14a and transmitted by the head mountable unit 14a as one or more past consumer communication signals to the commerce server 12. Past consumer communication signals provide guidance to the current consumer. The commerce server 12 can receive the past consumer communication signals from the past consumer and transmit the past consumer communication signals to the current consumer wearing the head mountable unit 14. The verbal statements of the past consumer can be emitted through a speaker 52 of the head mountable unit 14, allowing the current consumer to hear the past consumer's statements.

The past consumer can also receive video signals corresponding to the current consumer's field of view, so that the past consumer can see what the current consumer is seeing. The field of view of the current consumer can be captured by a camera 42 of the head mountable unit 14 and transmitted by the head mountable unit 14 as a current consumer communication signal to the commerce server 12. The commerce server 12 can receive a current consumer communication signal containing video data from the current consumer and transmit the current consumer communication signal to the past consumer wearing the head mountable unit 14a. The video feed corresponding to the current consumer's field of view can be displayed on a display 46a of the head mountable unit 14a, allowing the past consumer to see what the current consumer is seeing. The past consumer can use the video feed to direct the current consumer's gaze or hands to a particular location to better assist the current consumer.

The exchange of video and audio information can facilitate the current consumer's selection and purchase of an item from the retail store. It is noted that past consumers can be identified as being willing to assist current consumers prior to a help request signal being sent in some embodiments of the present disclosure. In one example, when a past consumer purchases the item (later to be considered for purchase by the current consumer), the past consumer can receive an e-receipt containing a query to confirm that the past consumer would be willing to assist future consumers. Past consumers can be encouraged to assist current consumers by being offered something of value, such as e-coupons, merchandise credits, or something else having pecuniary value.

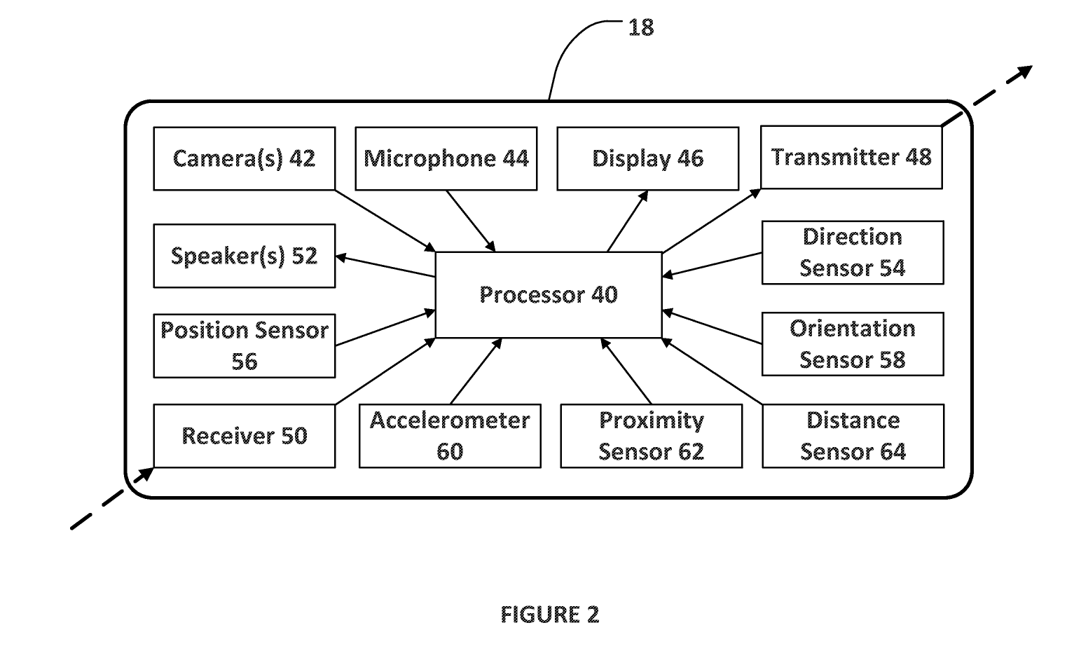

FIG. 2 is a block diagram illustrating exemplary components of the communications unit 18 of the head mountable unit 14. The communications unit 18 can include a processor 40, one or more cameras 42, a microphone 44, a display 46, a transmitter 48, a receiver 50, one or more speakers 52, a direction sensor 54, a position sensor 56, an orientation sensor 58, an accelerometer 60, a proximity sensor 62, and a distance sensor 64.

The processor 40 can be operable to receive signals generated by the other components of the communications unit 18. The processor 40 can also be operable to control the other components of the communications unit 18. The processor 40 can also be operable to process signals received by the head mount unit 14. While one processor 40 is illustrated, it should be appreciated that the term “processor” can include two or more processors that operate in an individual or distributed manner.

The head mount unit 14 can include one or more cameras 42. Each camera 42 can be configured to generate a video signal. One of the cameras 42 can be oriented to generate a video signal that approximates the field of view of the current consumer wearing the head mountable unit 14. Each camera 42 can be operable to capture single images and/or video and to generate a video signal based thereon. The video signal may be representative of the field of view of the current consumer wearing the head mountable unit 14.

In some embodiments of the disclosure, cameras 42 may be a plurality of forward-facing cameras 42. The cameras 42 can be a stereo camera with two or more lenses with a separate image sensor or film frame for each lens. This arrangement allows the camera to simulate human binocular vision and thus capture three-dimensional images. This process is known as stereo photography. The cameras 42 can be configured to execute computer stereo vision in which three-dimensional information is extracted from digital images. In such embodiments, the orientation of the cameras 42 can be known and the respective video signals can be processed to triangulate an object with both video signals. This processing can be applied to determine the distance that the current consumer is spaced from the object. Determining the distance that the current consumer is spaced from the object can be executed by the processor 40 or by the commerce server 12 using known distance calculation techniques.

Processing of the one or more, forward-facing video signals can also be applied to determine the identity of the object. Determining the identity of the object, such as the identity of an item in the retail store, can be executed by the processor 40 or by the commerce server 12. If the processing is executed by the commerce server 12, the processor 40 can modify the video signals limit the transmission of data back to the commerce server 12. For example, the video signal can be parsed and one or more image files can be transmitted to the commerce server 12 instead of a live video feed. Further, the video can be modified from color to black and white to further reduce transmission load and/or ease the burden of processing for either the processor 40 or the commerce server 12. Also, the video can cropped to an area of interest to reduce the transmission of data to the commerce server 12.

In some embodiments of the present disclosure, the cameras 42 can include one or more inwardly-facing camera 42 directed toward the current consumer's eyes. A video signal revealing the current consumer's eyes can be processed using eye tracking techniques to determine the direction that the current consumer is viewing. In one example, a video signal from an inwardly-facing camera can be correlated with one or more forward-facing video signals to determine the object the current consumer is viewing.

The microphone 44 can be configured to generate an audio signal that corresponds to sound generated by and/or proximate to the current consumer. The audio signal can be processed by the processor 40 or by the commerce server 12. For example, verbal signals can be processed by the commerce server 12 such as “this item appears interesting.” Such audio signals can be correlated to the video recording.

The display 46 can be positioned within the current consumer's field of view. Video content can be shown to the current consumer with the display 46. The display 52 can be configured to display text, graphics, images, illustrations and any other video signals to the current consumer. The display 46 can be transparent when not in use and partially transparent when in use to minimize the obstruction of the current consumer's field of view through the display 46.

The transmitter 48 can be configured to transmit signals generated by the other components of the communications unit 18 from the head mountable unit 14. The processor 40 can direct signals generated by components of the communications unit 18 to the commerce sever 12 through the transmitter 48. The transmitter 48 can be an electrical communication element within the processor 40. In one example, the processor 40 is operable to direct the video and audio signals to the transmitter 40 and the transmitter 48 is operable to transmit the video signal and/or audio signal from the head mountable unit 14, such as to the commerce server 12 through the network 20.

The receiver 50 can be configured to receive signals and direct signals that are received to the processor 40 for further processing. The receiver 50 can be operable to receive transmissions from the network 20 and then communicate the transmissions to the processor 40. The receiver 50 can be an electrical communication element within the processor 40. In some embodiments of the present disclosure, the receiver 50 and the transmitter 48 can be an integral unit.

The transmitter 48 and receiver 50 can communicate over a Wi-Fi network, allowing the head mountable device 14 to exchange data wirelessly (using radio waves) over a computer network, including high-speed Internet connections. The transmitter 48 and receiver 50 can also apply Bluetooth® standards for exchanging data over short distances by using short-wavelength radio transmissions, and thus creating personal area network (PAN). The transmitter 48 and receiver 50 can also apply 3G or 4G, which is defined by the International Mobile Telecommunications-2000 (IMT-2000) specifications promulgated by the International Telecommunication Union.

The head mountable unit 14 can include one or more speakers 52. Each speaker 52 can be configured to emit sounds, messages, information, and any other audio signal to the current consumer. The speaker 52 can be positioned within the current consumer's range of hearing. Audio content transmitted by the commerce server 12 can be played for the current consumer through the speaker 52. The receiver 50 can receive the audio signal from the commerce server 12 and direct the audio signal to the processor 40. The processor 40 can then control the speaker 52 to emit the audio content.

The direction sensor 54 can be configured to generate a direction signal that is indicative of the direction that the current consumer is facing. The direction signal can be processed by the processor 40 or by the commerce server 12. For example, the direction sensor 54 can electrically communicate the direction signal containing direction data to the processor 40 and the processor 40 can control the transmitter 48 to transmit the direction signal to the commerce server 12 through the network 20. By way of example and not limitation, the direction signal can be useful in determining the identity of an item(s) visible in the video signal, as well as the location of the current consumer within the retail store.

The direction sensor 54 can include a compass or another structure for deriving direction data. For example, the direction sensor 54 can include one or more Hall effect sensors. A Hall effect sensor is a transducer that varies its output voltage in response to a magnetic field. For example, the sensor operates as an analog transducer, directly returning a voltage. With a known magnetic field, its distance from the Hall plate can be determined. Using a group of sensors disposing about a periphery of a rotatable magnetic needle, the relative position of one end of the needle about the periphery can be deduced. It is noted that Hall effect sensors can be applied in other sensors of the head mountable unit 14.

The position sensor 56 can be configured to generate a position signal indicative of the position of the current consumer within the retail store. The position sensor 56 can be configured to detect an absolute or relative position of the current consumer wearing the head mountable unit 14. The position sensor 56 can electrically communicate a position signal containing position data to the processor 40 and the processor 40 can control the transmitter 48 to transmit the position signal to the commerce server 12 through the network 20.

Identifying the position of the current consumer can be accomplished by radio, ultrasound or ultrasonic, infrared, or any combination thereof. The position sensor 56 can be a component of a real-time locating system (RTLS), which is used to identify the location of objects and people in real time within a building such as a retail store. The position sensor 56 can include a tag that communicates with fixed reference points in the retail store. The fixed reference points can receive wireless signals from the position sensor 56. The position signal can be processed to assist in determining one or more items that are proximate to the current consumer and are visible in the video signal. The commerce server 12 can receive position data and identify the location of the current consumer in some embodiments of the present disclosure.

The orientation sensor 58 can be configured to generate an orientation signal indicative of the orientation of the current consumer's head, such as the extent to which the current consumer is looking downward, upward, or parallel to the ground. A gyroscope can be a component of the orientation sensor 58. The orientation sensor 58 can generate the orientation signal in response to the orientation that is detected and communicate the orientation signal to the processor 40. The orientation of the current consumer's head can indicate whether the current consumer is viewing a lower shelf, an upper shelf, or a middle shelf.

The accelerometer 60 can be configured to generate an acceleration signal indicative of the motion of the current consumer. The acceleration signal can be processed to assist in determining if the current consumer has slowed or stopped, tending to indicate that the current consumer is evaluating one or more items for purchase. The accelerometer 60 can be a sensor that is operable to detect the motion of the current consumer wearing the head mountable unit 14. The accelerometer 60 can generate a signal based on the movement that is detected and communicate the signal to the processor 40. The motion that is detected can be the acceleration of the current consumer and the processor 40 can derive the velocity of the current consumer from the acceleration. Alternatively, the commerce server 12 can process the acceleration signal to derive the velocity and acceleration of the current consumer in the retail store.

The proximity sensor 62 can be operable to detect the presence of nearby objects without any physical contact. The proximity sensor 62 can apply an electromagnetic field or a beam of electromagnetic radiation such infrared and assess changes in the field or in the return signal. Alternatively, the proximity sensor 62 can apply capacitive photoelectric principles or induction. The proximity sensor 62 can generate a proximity signal and communicate the proximity signal to the processor 40. The proximity sensor 62 can be useful in determining when a current consumer has grasped and is inspecting an item.

The distance sensor 64 can be operable to detect a distance between an object and the head mountable unit 14. The distance sensor 64 can generate a distance signal and communicate the signal to the processor 40. The distance sensor 64 can apply a laser to determine distance. The direction of the laser can be aligned with the direction that the current consumer is facing. The distance signal can be useful in determining the distance to an object in the video signal generated by one of the cameras 42, which can be useful in determining the current consumer's location in the retail store.

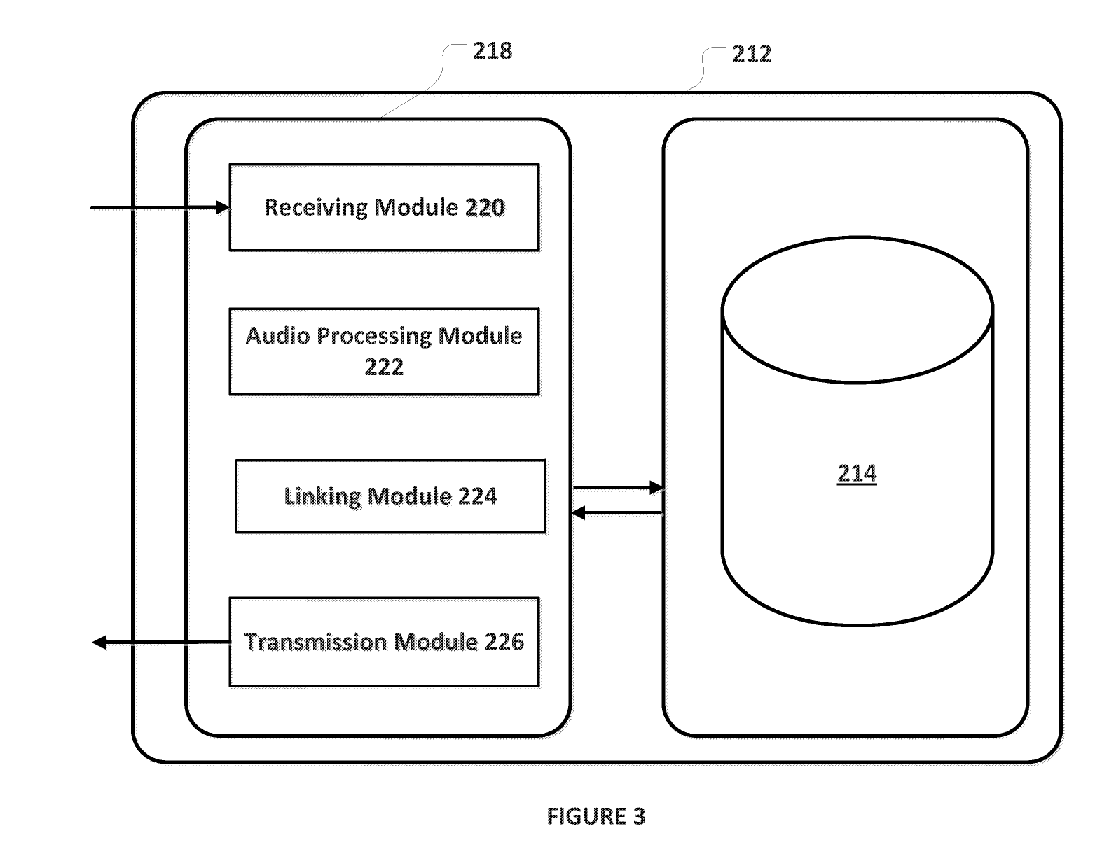

FIG. 3 is a block diagram illustrating a commerce server 212 according to some embodiments of the present disclosure. In the illustrated embodiment, the commerce server 212 can include a consumer database 214. The commerce server 212 can also include a processing device 218 configured to include a receiving module 220, an audio processing module 222, a linking module 224, and a transmission module 226.

Any combination of one or more computer-usable or computer-readable media may be utilized in various embodiments of the disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

The consumer database 214 can include in memory the identities of a plurality of consumers. The plurality of consumers can be the consumers who have purchased items in one or more retail stores that are associated with the commerce server 212. The consumer database 214 can also contain the purchase histories of each consumer. The data in the consumer database 214 can be organized based on one or more tables that may utilize one or more algorithms and/or indexes.

The processing device 218 can communicate with the database 214 and receive one or more signals from the head mountable unit 14 and from the head mountable unit 14a. The processing device 218 can include computer readable memory storing computer readable instructions and one or more processors executing the computer readable instructions.

The receiving module 220 can be operable to receive signals over the network 20, assess the signals, and communicate the signals or the data contained in the signals to other components of the commerce server 212. The receiving module 220 can be configured to receive help request signals and current consumer communication signals from one or more current consumers wearing respective augmented reality devices. The receiving module 220 can also be configured to receive one or more past consumer communication signals from one or more past consumers operating respective augmented reality devices.

The receiving module 220 can receive a signal containing audio data such as the voice of a current consumer. A signal containing audio data can be directed to the audio processing module 222 for further processing. Speech by a current consumer can be captured by the microphone 44 and transmitted to the commerce server 212 by the head mountable unit 14. The voice of the current consumer can be continuously monitored as the current consumer shops in some embodiments of the present disclosure.

The audio processing module 222 can analyze the audio data contained in a current consumer signal, such as verbal statements made by a current consumer. The audio processing module 222 can implement known speech recognition techniques to identify speech in an audio signal. The current consumer's speech can be encoded into a compact digital form that preserves its information. The encoding can occur at the head mountable unit 14 or at the commerce server 212. The audio processing module 222 can be loaded with a series of models honed to comprehend language. When encoded locally, the speech can be evaluated locally, on the head mountable unit 14. A recognizer installed on the head mountable unit 14 can communicate with the commerce server 212 to gauge whether the voice contains a command can be best handled locally or if the commerce server is better suited to execute the command. The audio processing module 222 can compare the current consumer's speech against a statistical model to estimate, based on the sounds spoken and the order in which the sounds were spoken, what letters might be contained in the speech. At the same time, the local recognizer can compare the speech to an abridged version of that statistical model applied by the audio processing module 222. For both the commerce server 212 and the head mountable unit 14, the highest-probability estimates are accepted as the letters contained in the current consumer's speech. Based on these estimations, the current consumer's speech, now embodied as a series of vowels and consonants, is then run through a language model, which estimates the words of the speech. Given a sufficient level of confidence, the audio processing module 222 can then create a candidate list of interpretations for what the sequence of words in your speech might mean. If there is enough confidence in this result, the audio processing module 222 can determine the current consumer's intent.

In a first example, a current consumer can state “I would like assistance” in an embodiment of the present disclosure. This statement can be contained in a signal received by the commerce server 212. The signal can be processed and the statement can be recognized by the audio processing module 222. In response, the audio processing module 222 can communicate the indication that sales assistance is requested to the linking module 224 for further processing, as will be set forth in greater detail below. Thus, the signal containing the current consumer's voice expressing a request for assistance can define a help request signal.

The linking module 224 can be configured to act on help requests contained in signals received from current consumers. In response to the detection of a help request by the audio processing module 222, the linking module 224 can search the consumer database 214 and identify a past consumer in the consumer database who purchased the item the current consumer is considering for purchase. The linking module 224 can direct the transmission module 226 to transmit a communication request signal to the head mountable unit 14a. If the past consumer rejects the communication request signal, the linking module 224 can search the consumer database 214 to find another past consumer.

Upon identifying a past consumer willing to assist the current consumer, the linking module 224 can direct the transmission module 226 to transmit a signal to the head mountable unit 14a. The initial signal transmitted to the head mountable unit 14a can be a communication request signal and can contain the help request signal itself, such the voice of the current consumer. In some embodiments of the present disclosure, the initial signal transmitted to the head mountable unit 14a can also contain an explanation of the request, such as the reminder that the past consumer has purchased the item that is the subject of the help request. Subsequent current consumer communication signals can also be directed to the head mountable unit 14a.

The head mountable unit 14a can respond to the initial help request signal from the commerce server 212 and subsequent current consumer communication signals by transmitting one or more past consumer communication signals back to the commerce server. The initial signal can be an acceptance signal. The acceptance signal can be an audio signal, such as the past consumer's voice stating “yes, I will help.” The receiving module 220 can be configured to direct initial past consumer communication signals to the audio processing module 222 so that the past consumer's willingness to help can be ascertained. If the past consumer is willing to help the current consumer, the receiving module 220 can be configured to direct subsequent past consumer communication signals to the linking module 224, bypassing the audio processing module 222. The linking module 224 can direct the transmission module 226 to transmit past consumer communication signals to the head mountable unit 14. Thus, the linking module 224 can facilitate continuous and real time communication between the current consumer and the past consumer.

After receiving an initial help request signal from the current consumer, the linking module 224 can direct the receiving module 222 to direct audio and video signals received from the head mountable unit 14 directly to the linking module 224 and bypass the audio processing module 222. The linking module 224 can then direct the transmission module 226 to transmit these signals, current consumer communication signals, to the head mountable unit 14a.

The past consumer or the current consumer can stop transmissions to the commerce server 212 to end the sales help interaction. The linking module 224 can then direct the receiving module 220 to again direct audio signals from the head mountable unit 14 to the audio processing module 222.

It is noted that the various processing functions set forth above can be executed differently than described above in order to enhance the efficiency of an embodiment of the present disclosure in a particular operating environment. The processor 40 can assume a greater role in processing some of the signals in some embodiments of the present disclosure. For example, in some embodiments, the processor 40 on the head mountable unit 14 could modify the video stream to require less bandwidth. The processor 40 could convert a video signal containing color to black and white in order to reduce the bandwidth required for transmitting the video signal. In some embodiments, the processor 40 could crop the video, or sample the video and display frames of interest. A frame of interest could be a frame that is significantly different from other frames, such as a generally low quality video having an occasional high quality frame. Thus, in some embodiments, the processor 40 could selectively extract video or data of interest from a video signal containing data of interest and other data. Further, the processor 40 could process audio signals received through the microphone 44, such signals corresponding to audible commands from the current consumer.

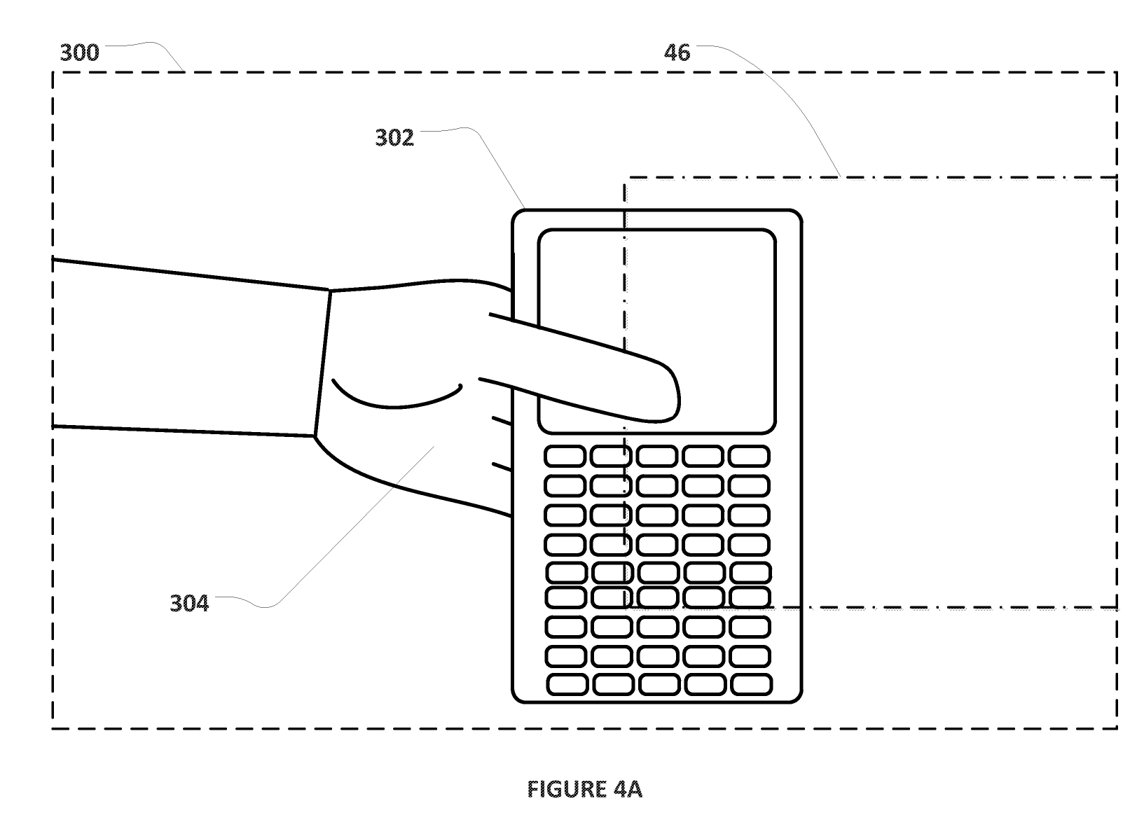

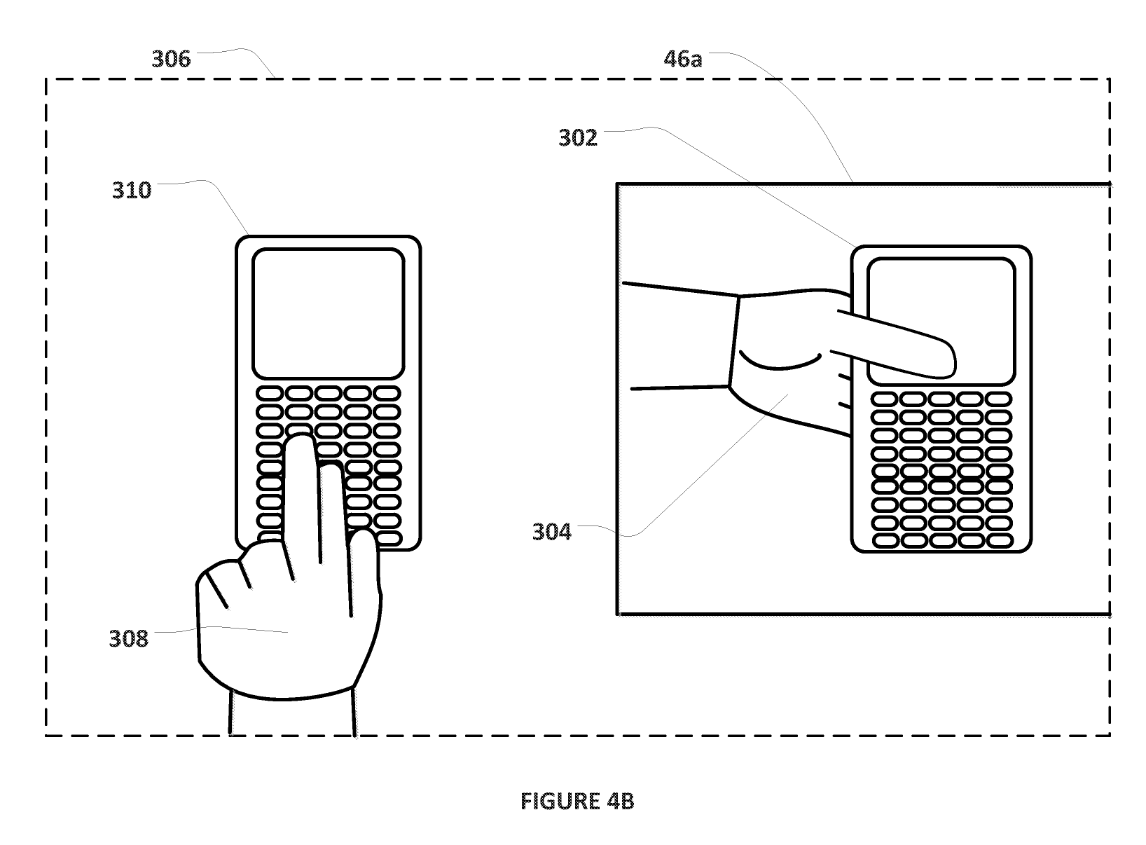

FIG. 4A is an exemplary field of view of a current consumer while shopping in some embodiments of the present disclosure. This field of view can be captured by a camera 42 of a head mountable unit 14 worn by the current consumer and transmitted as a video signal to the commerce server 212 in some embodiments of the present disclosure. The current consumer's field of view is bounded in this example by the box referenced at 300. A portion of the current consumer's field of view can be overlapped by the display 46 of an augmented reality device such as the head mountable unit 14. In FIG. 4A, the display 46 is not engaged and can therefore be substantially transparent. The boundary of the display 46 is illustrated by dashed lines and not solid lines to enhance the clarity of the other elements of FIG. 4A.

The current consumer can be viewing an item 302. The exemplary item 302 can be a calculator that a current consumer is considering for purchase. In FIG. 4A, the consumer's hand 304 is shown holding the item 302. In some embodiments of the present disclosure, the current consumer can initiate sales assistance with the augmented reality device, such as by stating “please help me with this item.” The statement can be contained in an audio signal transmitted to the commerce server 212 by the head mountable unit 14. The commerce server 212 can detect the speech in the audio signal and recognize the signal as a help request signal.

In response to the request for sales assistance, the commerce server 212 can search for a past consumer that purchased the calculator 302. After finding such a past consumer, the commerce server 212 can transmit a communication request signal to that past consumer. If the past consumer accepts the help request from the current consumer, the commerce server 212 can establish a communication link between the current consumer and the past consumer by establishing link between the head mountable unit 14 and the head mountable unit 14a.

FIG. 4B is an exemplary field of view of a past consumer while assisting a current consumer in some embodiments of the present disclosure. This field of view can be captured by a camera 42a of a head mountable unit 14a worn by the past consumer and transmitted as a video signal to the commerce server 212 in some embodiments of the present disclosure. The past consumer's field of view is bounded in this example by the box referenced at 306. A portion of the current consumer's field of view can be overlapped by the display 46a of an augmented reality device such as the head mountable unit 14a. In FIG. 4B, the display 46a is engaged and is displaying the field of view captured by the camera 42 of the head mountable unit 14. This is the view shown in FIG. 4A.

FIG. 4B shows the past consumer's hand 308 manipulating the item 310 which can be identical to the item 302. The past consumer can be using the item 310 while addressing questions posed by the current consumer as the current consumer considers purchasing the item 302. It is noted that the past consumer's field of view can be captured by a camera 42a of the head mountable unit 14a, transmitted to the commerce server 212, and ultimately displayed by the display 46. This would allow the current consumer to see how the item 302 can be used.

The past consumer could communicate with the current consumer with something other than a head mountable unit in some embodiments of the present disclosure. Past consumers could interface with current consumers through existing telephone systems such as cell phones or some form of voice over Internet protocol. This could be more convenient to the past consumer and enhance the past consumer's willingness to help the current consumer. Video exchanges could be available through a service such as Facetime or Skype. Further, to enhance the convenience of the past consumer, the past consumer could define times that the past consumer would be willing to assist current consumers. This data could be among the data stored in the consumer database 214 about the past consumer.

It is noted that in some embodiments of the present disclosure, the past consumer can be reward for assisting the current consumer. For example, a system according to an embodiment of the present disclosure can update the data associated with the past consumer in the consumer database by adding one or more e-coupons that can be applied by the past consumer. In other embodiments, a past consumer can be credited with a merchandise credit or some other form of pecuniary benefit.

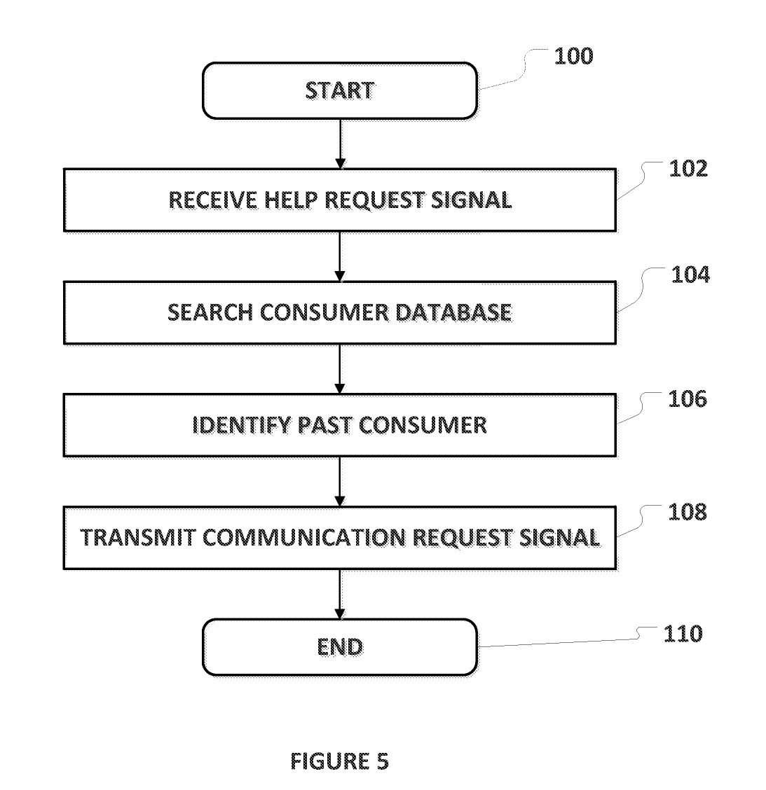

FIG. 5 is a flow chart illustrating a method that can be carried out in some embodiments of the present disclosure. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

FIG. 5 is a flow chart illustrating a method that can be carried out in some embodiments of the present disclosure. The method can be executed by a commerce server. The commerce server can be located at the retail store or can be remote from the retail store. The method starts at step 100. At step 102, the commerce server can receive a help request signal from an augmented reality device worn by a current consumer shopping in a retail store.

At step 104, the commerce server can search a consumer database containing purchase histories for a plurality of past consumers. At step 106, the commerce server can identify a past consumer in the consumer database who purchased the item that the current consumer is considering for purchase. At step 106, the commerce server can transmit a communication request signal to a second augmented reality device worn by the past consumer containing data indicative of a request that the past consumer communicate with the current consumer about the item. The past consumer can assist the current consumer in considering the item for purchase. The exemplary process ends at step 110.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The above description of illustrated examples of the present disclosure, including what is described in the Abstract, are not intended to be exhaustive or to be limitation to the precise forms disclosed. While specific embodiments of, and examples for, the present disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A computer-implemented method comprising:
receiving, with a processing device of a commerce server, a help request signal from a first augmented reality device worn by a current consumer considering an item for purchase in a retail store;
searching, with the processing device, a consumer database wherein the consumer database contains purchase histories for a plurality of past consumers;
identifying, with the processing device, a past consumer in the consumer database who purchased the item; and
transmitting, with the processing device, a communication request signal to a second augmented reality device worn by the past consumer containing data indicative of a request that the past consumer communicate with the current consumer about the item, such that the past consumer can assist the current consumer in considering the item for purchase.

2. The computer-implemented method of claim 1 further comprising:
receiving, with the processing device, an acceptance signal from the second augmented reality device containing data indicative of an acceptance that the past consumer will communicate with the current consumer about the item.

3. The computer-implemented method of claim 2 further comprising:
linking, with the processing device, the first augmented reality device in communication with the second augmented reality device in response to said step of receiving the acceptance signal.

4. The computer-implemented method of claim 3 wherein said linking step further comprises:
receiving, with the processing device, a current consumer communication signal from the first augmented reality device containing audio data; and
transmitting, with the processing device, the current consumer communication signal to the second augmented reality device.

5. The computer-implemented method of claim 4 wherein said step of receiving the current consumer communication signal further comprises:
receiving, with the processing device, the current consumer communication signal from the first augmented reality device, wherein the current consumer communication signal contains a voice of the current consumer.

6. The computer-implemented method of claim 3 wherein said linking step further comprises:
receiving, with the processing device, a current consumer communication signal from the first augmented reality device containing video data; and
transmitting, with the processing device, the current consumer communication signal to the second augmented reality device.

7. The computer-implemented method of claim 6 wherein said step of receiving the current consumer communication signal further comprises:
receiving, with the processing device, the current consumer communication signal from the first augmented reality device, wherein the current consumer communication signal contains at least part of a field of view the current consumer.

8. The computer-implemented method of claim 3 wherein said linking step further comprises:
receiving, with the processing device, a past consumer communication signal from the second augmented reality device containing audio data; and
transmitting, with the processing device, the past consumer communication signal to the first augmented reality device.

9. The computer-implemented method of claim 8 wherein said step of receiving the past consumer communication signal further comprises:
receiving, with the processing device, the past consumer communication signal from the second augmented reality device, wherein the past consumer communication signal contains a voice of the past consumer.

10. The computer-implemented method of claim 3 wherein said linking step further comprises:
receiving, with the processing device, a past consumer communication signal from the second augmented reality device containing video data; and
transmitting, with the processing device, the past consumer communication signal to the first augmented reality device.

11. The computer-implemented method of claim 10 wherein said step of receiving the past consumer communication signal further comprises:
receiving, with the processing device, the past consumer communication signal from the second augmented reality device, wherein the past consumer communication signal contains a plurality of images of the item with at least one image showing the item in use.

12. The computer-implemented method of claim 2 further comprising:
rewarding, with the processing device, the past consumer in response to the step of receiving the acceptance signal.

13. The computer-implemented method of claim 12 wherein said rewarding step further comprises:
transmitting, with the processing device, an e-coupon to the past consumer.

14. The computer-implemented method of claim 1 wherein said step of receiving the help request signal further comprises:
receiving, with a processing device of a commerce server, a help request signal containing audio data from the first augmented reality device.

15. The computer-implemented method of claim 14 wherein said step of receiving the help request signal is further defined as:
receiving, with a processing device of a commerce server, the help request signal containing the consumer's voice from the first augmented reality device.

16. A computer-implemented method comprising:
offering a plurality of items for sale at a plurality of retail stores;
receiving, with a processing device of a commerce server, a help request signal from a first augmented reality device worn by a current consumer considering an item for purchase in one of the plurality of retail stores;
searching, with the processing device, a consumer database wherein the consumer database contains purchase histories for a plurality of past consumers;
identifying, with the processing device, a past consumer in the consumer database who purchased the item;
transmitting, with the processing device, a communication request signal to a second augmented reality device worn by the past consumer containing data indicative of a request that the past consumer communicate with the current consumer about the item; and
linking, with the processing device, the first augmented reality device in communication with the second augmented reality device after said transmitting step.

17. The computer-implemented method of claim 16 wherein said linking step further comprises:
exchanging, with the processing device, communication signals between the first and second augmented reality devices.

18. The computer-implemented method of claim 16 wherein said linking step further comprises:
placing, with the processing device, the current and past consumers in real time communication with one another through the first and second augmented reality devices.

19. The computer-implemented method of claim 16 said linking step further comprises:
imparting, with the processing device, pecuniary benefit to the past consumer.

20. A consumer assistance system comprising:
a commerce server having a processing device including:
a receiving module configured to receive a help request signal from a first augmented reality device worn by a current consumer shopping in a retail store;
an audio processing module configured to determine that the help request signal contains data indicative of a request for sales assistance; and
a linking module configured to link the first augmented reality device in communication with a second augmented reality device physically remote from the first augmented reality device, wherein an operator of the second augmented reality device is operable to assist the consumer.
